(19) United States
(12) Patent Application Publication
(10) Pub. No.: US 2014/0352627 A1
(43) Pub. Date: Dec. 4, 2014

(54) COLLAPSIBLE KENNEL

(71) Applicant: SportPet Designs, Inc., Waukesha, WI (US)

(72) Inventor: KELLY C. KELLOGG, Oconomowoc, WI (US)

(73) Assignee: SportPet Designs, Inc., Waukesha, WI (US)

(21) Appl. No.: 14/018,566

(22) Filed: Sep. 5, 2013

Related U.S. Application Data
(63) Continuation-in-part of application No. 13/904,605, filed on May 29, 2013.

(51) Int. Cl. A01K 1/02

(52) U.S. Cl. CPC A01K 1/0245
USPC 119/498

(57) ABSTRACT

A collapsible enclosure having a top panel, a bottom panel, two side panels, a front panel having an opening, and a rear panel. The top panel, bottom panel, two side panels, front panel, and rear panel are connected to one another to form a substantially rectangular enclosure having a door in the opening for ingress and egress. The side panels include a peripheral edging containing a looped frame. A method of collapsing the kennel is also disclosed.

### RELATED APPLICATIONS

This application is a continuation-in-part of co-pending U.S. Ser. No. 13/904,605, filed 29 May 2013.

### BACKGROUND OF THE INVENTION

The present invention relates generally to collapsible structures and specifically to a collapsible container for use by pets.

Certain devices are known in the art to provide an enclosure or structure for temporarily containing or for transporting a pet or other objects. For example, U.S. Pat. No. 6,539,895 to Hoagland teaches a portable pet carrier having a top portion, a middle section and a bottom portion made primarily from a molded synthetic material, with the top portion having a handle-like structure for carrying the assembled pet carrier and the middle portion having holes for ventilation and a door or window-like structure for placing a pet in or removing a pet from the carrier. Other pet enclosures are known in the art to be collapsible. These devices commonly have a square footprint and a domed configuration, which creates a pet enclosure that is larger than necessary because of unutilized space. As the size of the enclosure increases, its cost increases and its integrity decreases.

The prior art pet enclosures are voluminous in their expanded state, are either non-collapsible or are uneasy to fold or collapse, are still relatively voluminous in their collapsed state, and are difficult to manipulate. These configurations require more space, consume more materials, and require stronger collapsible framing than are necessary to efficiently contain or transport pets or other objects. The present invention solves the above-mentioned shortcomings and provides a convenient, easy to manipulate, and more efficiently sized ergonomic enclosure for containing and transporting pets or other objects.

### SUMMARY OF THE INVENTION

The present invention relates generally to a collapsible structure and specifically to a collapsible structure for use as an animal kennel and method of making and using the same.

According to the present invention, the foregoing and other advantages are obtained by providing a collapsible kennel comprising a plurality of panels including opposed side panels, a top panel, and a floor panel, forming an enclosure having two ends, one end having an opening. In the preferred embodiment, each side panel comprises a flexible continuous loop frame, a web of material, and an edging material. The edging material envelops the loop frame and is coupled to the periphery of the web. Each end includes a periphery having an edging material. The edging material envelops a loop frame in a manner similar to that of the side panels. Each end is further provided with a rigid border member to support either a kennel door for ingress and egress, or a mesh panel as will be discussed, thus forming the structure.

A preferred method of manufacturing the collapsible kennel includes the steps of coupling edging to selected webs such that the edging surrounds the perimeter of the web and forms a channel or pocket through which the frame will later be inserted. After the requisite number of side panels having edging has been formed, opposed sides of the floor panel are each attached to the bottom side of a side panel. Next, the top side of each side panel is connected with opposed sides of the top panel. A flexible frame for each side panel is inserted through the channel formed by each edging. The ends of each frame member are connected, preferably using a crimped butt connector, to give the collapsible kennel its ability to freely stand in a rigid, expanded, upright state. Next, an edging is coupled to the periphery of each end and a flexible frame for each periphery is inserted through the channel formed by each edging. The ends of each frame member are connected in manner similar to that used for the side panels. A rigid border member is attached to each end. The rigid border members are adapted to support closure structures such as a kennel door or ventilated mesh webbing.

From the expanded state, the kennel can be folded and collapsed for storage or transportation. The preferred steps of collapsing the kennel include grasping the rigid border member of the entrance end and rotating it 180° while compressing the side panels until the side panels are spiraled against each other and the rigid border members are adjacent and overlay each other. While the kennel is now collapsed, downward pressure is required to prevent the kennel from springing back into an expanded state. Next, the fastener members on a rigid border member are pivoted to catch a corresponding latch member on an opposite rigid border member to thereby hold the kennel in the collapsed state for storage.

### BRIEF DESCRIPTION OF THE DRAWINGS

FIG. 1 is a perspective view of a collapsible kennel according to the present invention.

FIG. 2 is a perspective view similar to that of FIG. 1, but showing the door open with a dog inside.

FIG. 3 is a perspective view of the kennel in collapsed condition.

FIG. 4 is a front plan view of the collapsible kennel.

FIG. 5 is a rear plan view of the collapsible kennel.

FIG. 6 is a side plan view of the collapsible kennel.

FIGS. 7-11 depict a method of collapsing the collapsible kennel, and using a fastener and latch system to hold the collapsed kennel in the collapsed state.

FIG. 12 is a cutaway view of the collapsible kennel illustrating the interrelationship of the various components in while in expanded condition.

FIG. 13 is a fragmentary cutaway view showing attachment of a rigid frame member to the open end loop frame.

FIG. 14A is an enlarged cross sectional view of the loop frame used in the open ends.

FIG. 14B is an enlarged cross sectional view similar to that of FIG. 14A, but showing the loop frame used in the side panels.

FIG. 15 is an exploded view of the collapsible kennel.

FIG. 16 is a side plan view, similar to FIG. 6, but showing an alternative collapsible kennel.

FIG. 17 is a rear plan view of the collapsible kennel illustrated in FIG. 16.

FIG. 18 is an exploded view of the collapsible kennel illustrated in FIGS. 16 and 17.

FIGS. 19 and 20 illustrate a method of expanding the kennel shown in FIGS. 16-18.

FIG. 21 is a perspective view of the kennel illustrated in FIGS. 16-20, but in collapsed condition.

FIG. 22 is a perspective view of an alternative collapsible kennel according to the present invention and showing hand hold apertures.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

As shown in the Figures, a collapsible enclosure 10 according to the present invention comprises a top panel 12, a bottom panel 14, two side panels 20, a front panel 30 having a door 32, and a rear panel 40. The top panel 12, bottom panel 14, two side panels 20, front panel 30, and rear panel 40 are connected to one another to form a substantially rectangular enclosure 10 having the door 32 for ingress and egress.

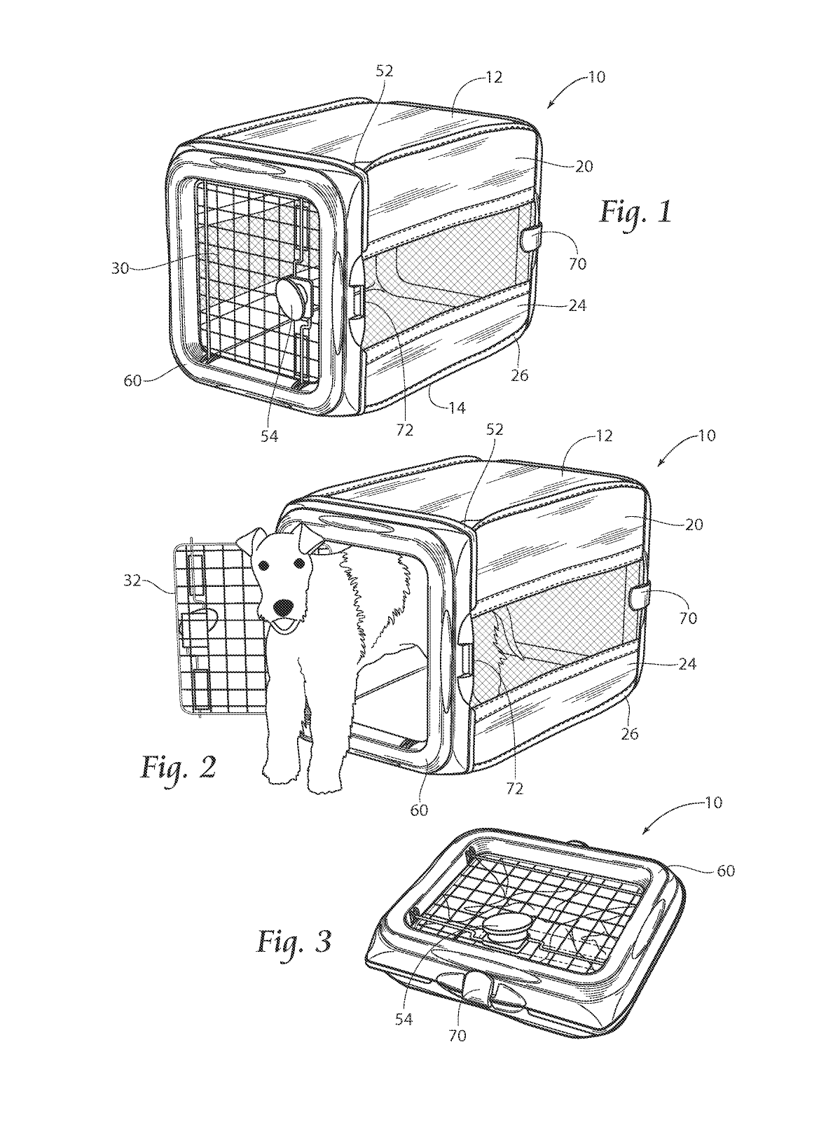

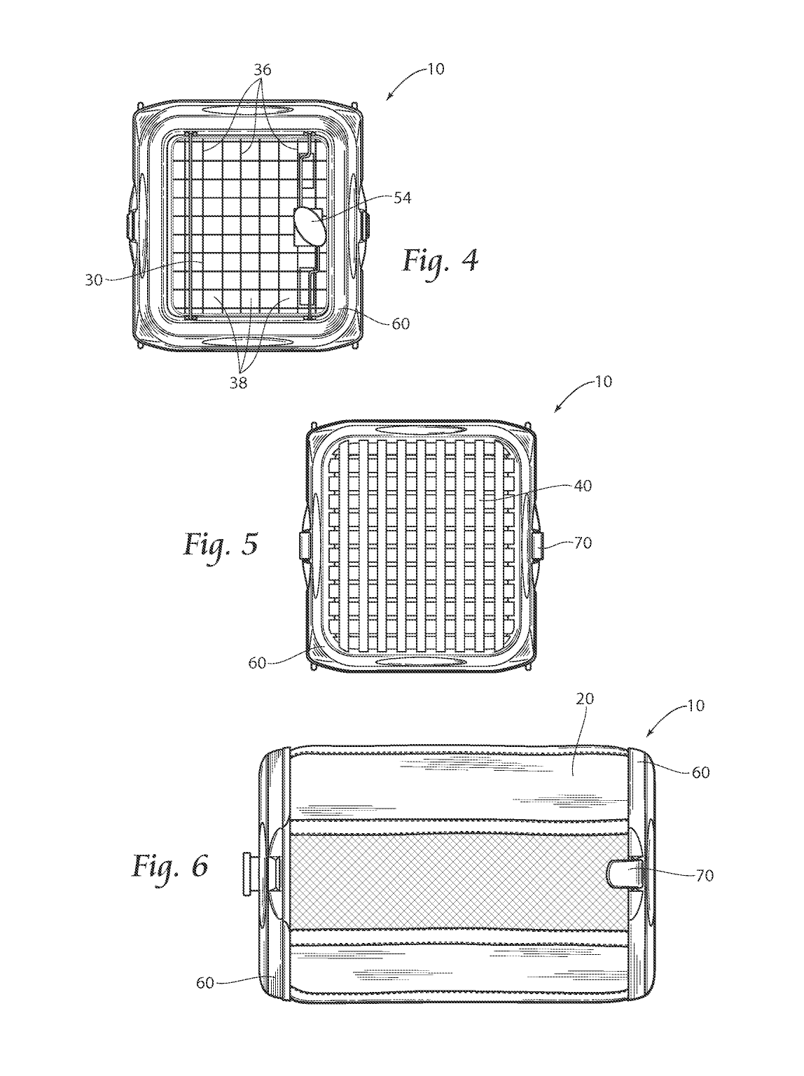

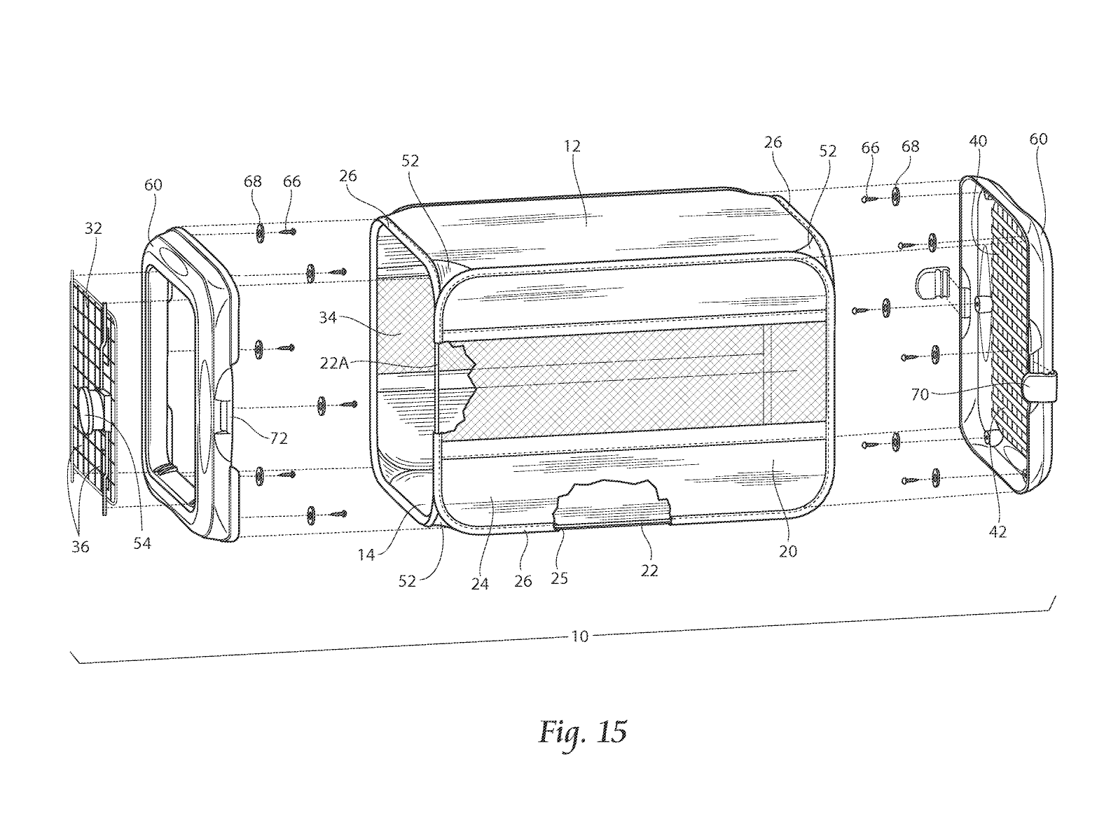

Referring to FIGS. 1-6 and 15 it may be seen that each side panel 20 comprises a frame 22, a web 24, and an edging 26. The frame 22 is flexible, preferably formed from a sufficiently stiff yet resilient material such as spring steel wire or plastic, and may form a loop that may or may not be continuous. Preferably, the frame 22 has a rectangular cross-section, as seen in FIG. 14B. The frame 22 is contained within the channel or pocket 25 formed by the edging 26 (best seen in FIG. 15). The webs 24 are a flexible foldable material, such as nylon cloth or nylon mesh, but can be any suitably flexible material. The nylon, or other flexible material, may be solid or perforated. The perimeter of the web 24 is stitched to the edging 26 such that the edging 26 forms a pocket 25 about the periphery of the web 24. The edging 26 is a foldable, but stretch-resistant material capable of housing the frame 22 within its pocket 25.

As best seen in FIGS. 1 and 15, the top panel 12 and bottom panel 14 preferably each comprise a continuous and non-interrupted foldable material. Each side panel web 24 preferably comprises a continuous and non-interrupted mesh material, or alternatively, may comprise a combination of mesh material and non-mesh foldable material.

With particular reference now to FIG. 15, the front panel 30 is seen to have a generally rectangular shape having a periphery that defines a front opening 34. Further seen is the rear panel 40 which also has a generally rectangular shape having a periphery. The periphery of both the front panel 30 and the rear panel 40 includes an edging 26. The edging 26 forms a pocket 25 about the periphery of the front panel 30 and the rear panel 40 and, similar to the edging 26 discussed in conjunction with the side panels 20, is a foldable, but stretch-resistant material capable of housing a frame 22A within its pocket 25. As seen in FIG. 14A, the frame 22A used in conjunction with the front panel 30 and the rear panel 40 preferably has a round cross section. In construction, the top panel 12 and the bottom panel 14 each include four corner sections 52 which are attached to four substantially perpendicular sides of each side panel 20, the front panel periphery, and the rear panel periphery.

With reference now to FIGS. 13 and 15, a rigid border member 60 is positioned over and is attached to the edging 26 of the front panel 30. As seen, the rigid border member 60 may include a mounting element 62 having an abutment 64 to support the frame 22A in its pocket 25. The abutment 64 may be further adapted to receive a fastener, such as the screw 66 and washer 68 combination shown. A door member 32 is preferably positioned within the rigid border member 60 and provides ingress and egress for the enclosure 10. A door 32 for use with the present invention may be any suitable kennel-type door structure. The door structure 32 illustrated is a grate-type structure and includes a plurality of cross bars 36 which may be spaced to define transversely spaced openings 38 configured to permit airflow, visibility, and retain a pet as desired. The cross bars 36 may also be configured to engage and be supported by the rigid border member 60 for attachment thereto. A knob 54 or other latching mechanism may be further provided for latching access to the container 10.

In a manner similar to that of the front panel 30, a rigid border member 60 is positioned over and is attached to the edging 26 of the rear panel 40. As with the front panel 30, the rigid border member 60 used in conjunction with the rear panel 40 may include a mounting element 62 adapted to support the frame 22A in its pocket 25 and further to receive a fastener such as the screw 66 and washer 68 combination shown in FIGS. 13 and 15. A woven air permeable mat 42 or other similar material is preferably positioned within the rear rigid border member 60 and provides enhanced air circulation for the enclosure 10 when used as a pet kennel. One of the rigid border members 60 is further preferably provided with latches 70 which may be moved between open and closed positions. The latches 70 engage corresponding protruding catches 72 on the opposite rigid border member 60 to thereby hold the kennel in the collapsed state for storage, as will be discussed.

Although stitching is presented as the preferred means for attaching or connecting the elements of the kennel 10 and permitting relatively convenient folding of the kennel 10, it is to be understood that other methods of attachment can be used in this invention. Such other methods may include heat sealing, gluing and the like. Accordingly, construction of the collapsible kennel should not be limited to stitching alone.

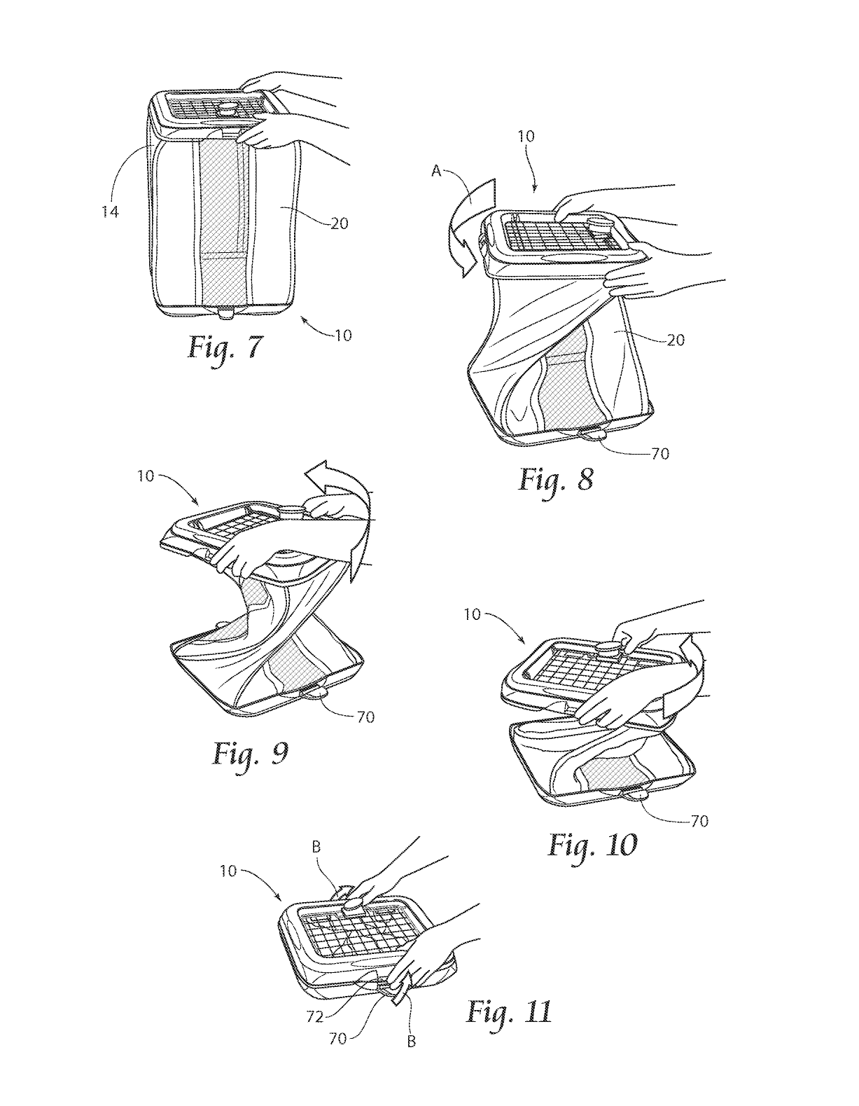

From the expanded state, the kennel 10 may be folded into a collapsed state for storage and transportation. FIGS. 7 to 11 show various steps for collapsing the kennel 10. Referring to FIG. 7, the first step requires positioning the kennel with the front panel 30 on top, grasping the rigid border member 60 and rotating 180° in the direction of arrow A while compressing the side panels 20 until the side panels 20 are spiraled against each other and the rigid border members 60 are adjacent and overlay each other. The kennel 10 is now collapsed, but downward pressure is still required to prevent the kennel 10 from springing back into an expanded state. FIG. 11 shows the final step of pivoting the latch members 70 on a rigid border member 60 in the direction of arrow B to catch a corresponding catch member 72 on an opposite rigid border member 60 to thereby hold the kennel in the collapsed state for storage.

When the latch members 70 are uncoupled from the latch members 72, the frame members 22 will bias the kennel 10 into its fully expanded state. Again, the fully expanded state of the embodiment is that shown in FIG. 1.

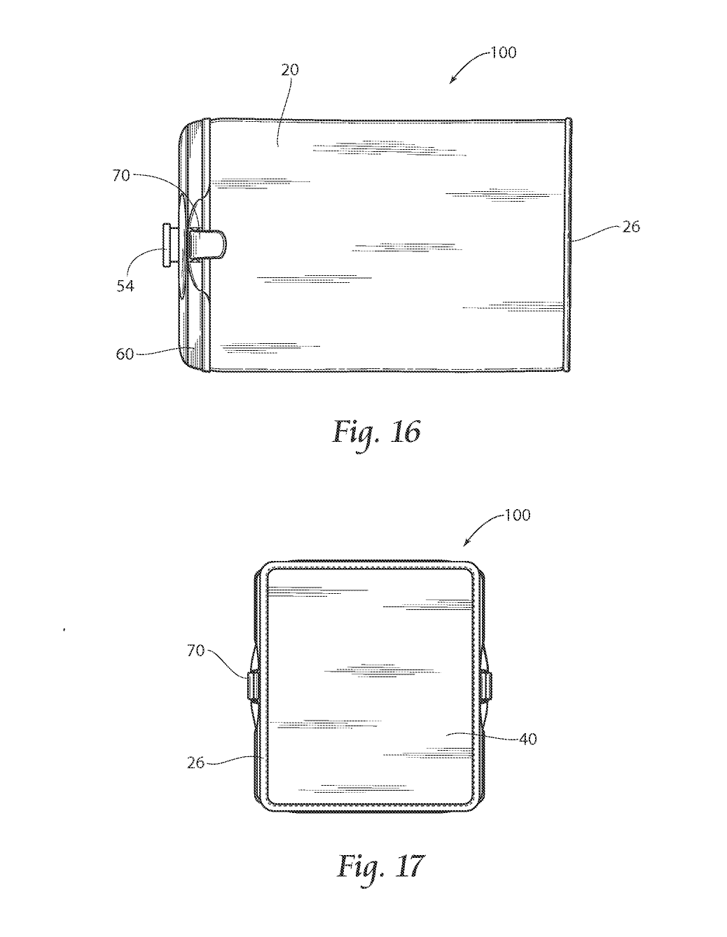

With attention now to FIGS. 16-21, another embodiment of a collapsible kennel 100 may be seen. Similar to the previously described device 10, the collapsible kennel 100 in these views comprises a top panel 12, a bottom panel 14, two side panels 20, a front panel 30 having a door 32, and a rear panel 40. The top panel 12, bottom panel 14, and two side panels 20 are connected to one another to form a substantially rectangular enclosure 100. The panels 12, 14, and 20 may be formed from a flexible foldable material, such as nylon cloth or nylon mesh, but can be any suitably flexible material. Further, the material may be solid or perforated.

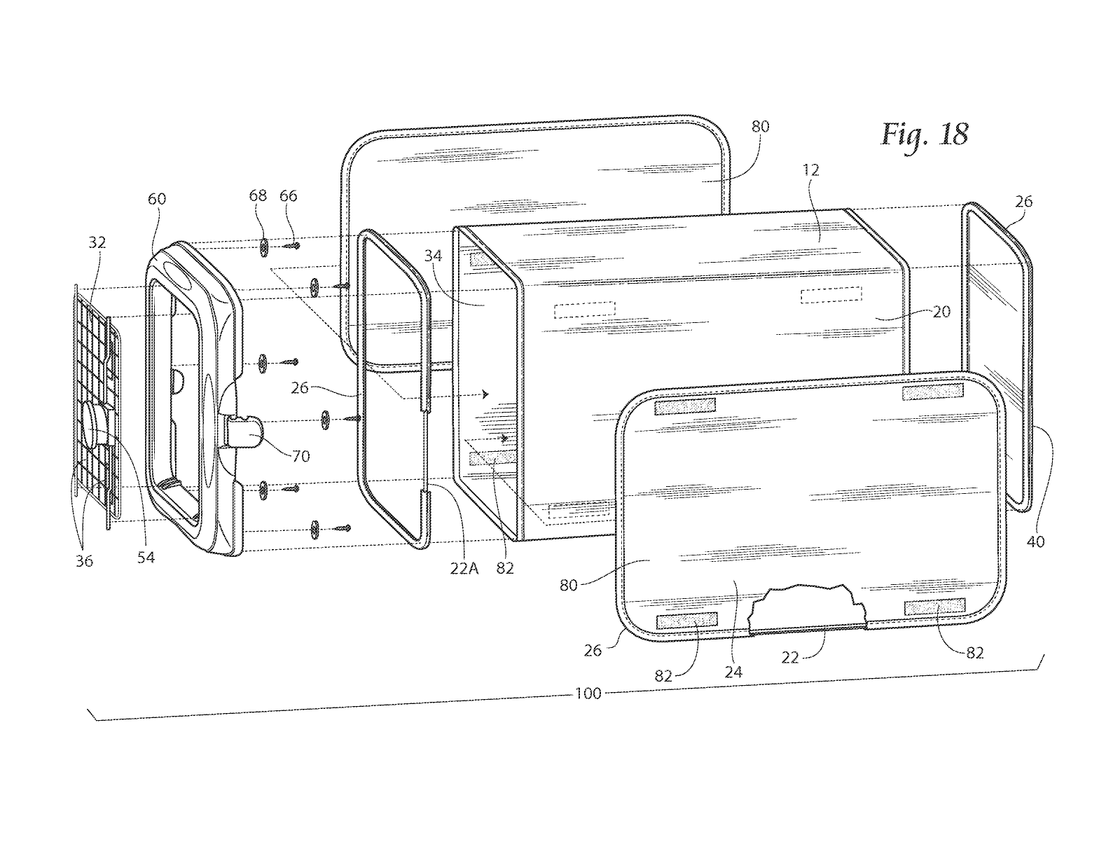

Referring particularly to FIG. 18 it may be seen that the front panel 30 and the rear panel 40 each include a frame 22 and an edging 26. The frame 22 is flexible, preferably formed from a sufficiently stiff yet resilient material such as spring steel wire or plastic, and may form a loop that may or may not be continuous. The frame 22 is contained within the channel or pocket 25 formed by the edging 26.

As may be further seen in the view of FIG. 18, the device 100 may further include a plurality of insert panels 80. The insert panels 80 provide shape and rigidity to the device 100 while in the expanded condition. As viewed, the insert panels 80 each comprise a frame 22, a web 24, and an edging 26. Similar to frames 22 described previously, the frames 22 utilized in the insert panels 80 are flexible, preferably formed from a sufficiently stiff yet resilient material such as spring steel wire or plastic that may form a loop that may or may not be continuous. The frame 22 is contained within the channel or pocket 25 formed by the edging 26. The webs 24 are a flexible foldable material, such as nylon cloth or nylon mesh, but can be any suitably flexible material. The nylon, or other flexible material, may be solid or perforated. The perimeter of the web 24 is stitched to the edging 26 such that the edging 26 forms a pocket 25 about the periphery of the web 24. The edging 26 is a foldable, but stretch-resistant material capable of housing the frame 22 within its pocket 25. The insert panels 80 may be further provided with means for attachment to the side panels 20, such as the hook and loop fasteners 82 shown. In use, the insert panels 80 are placed in the device 100 and positioned adjacent the side panels 20 for rigidity, as will be discussed.

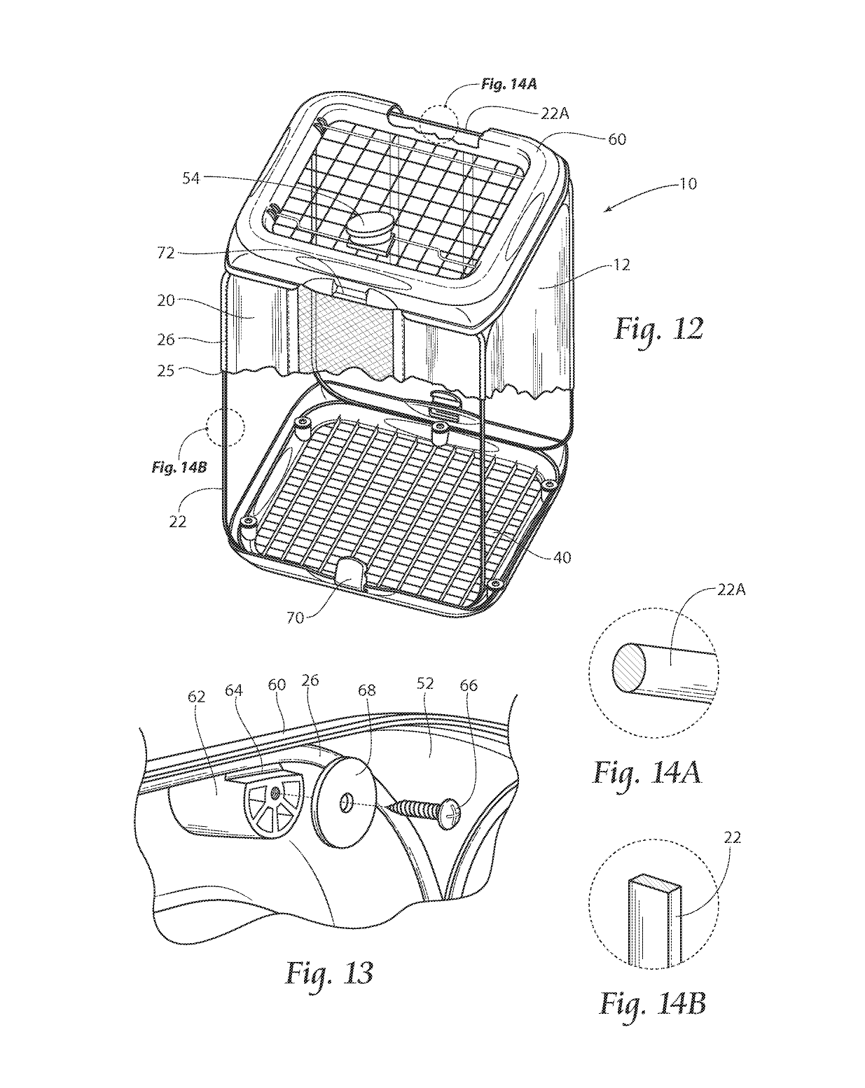

With further reference to FIG. 18, a rigid border member 60 is positioned over and is attached to the edging 26 of the front panel 30. As illustrated, and similar to the rigid border member 60 discussed with regard to FIGS. 1-15, the rigid border member 60 shown in this view may include a mounting element 62 (see FIG. 13) to support the frame 22 in its pocket 25. As in the previous embodiment, an abutment 64 such as that shown in FIG. 13 may be further adapted to receive a fastener, such as the screw 66 and washer 68 combination shown. A door member 32 is preferably positioned within the rigid border member 60 to provide ingress and egress for the enclosure 100. A door 32 for use with the present invention may be any suitable kennel-type door structure, such as the grate-type structure illustrated. As in the previous embodiment, the door 32 may include a plurality of cross bars 36 which may be spaced to define transversely spaced openings 38 configured to permit airflow, visibility, and retain a pet as desired. The cross bars 36 may also be configured to engage and be supported by the rigid border member 60 for attachment thereto. A knob 54 or other latching mechanism may be further provided for latching access to the container 100.

With regard to the rear panel 40, a web 24 may be attached to the edging 26 in a manner similar to that of the insert panels 80. The web 24 may perforate or imperforate, as desired and formed from any suitably flexible material. The rigid border member 60 attached to the front panel 30 is further preferably provided with latches 70 which may be moved between open and closed positions. The latches 70 engage the edging 26 of the rear panel 40 to thereby hold the kennel in the collapsed state for storage, as will be discussed.

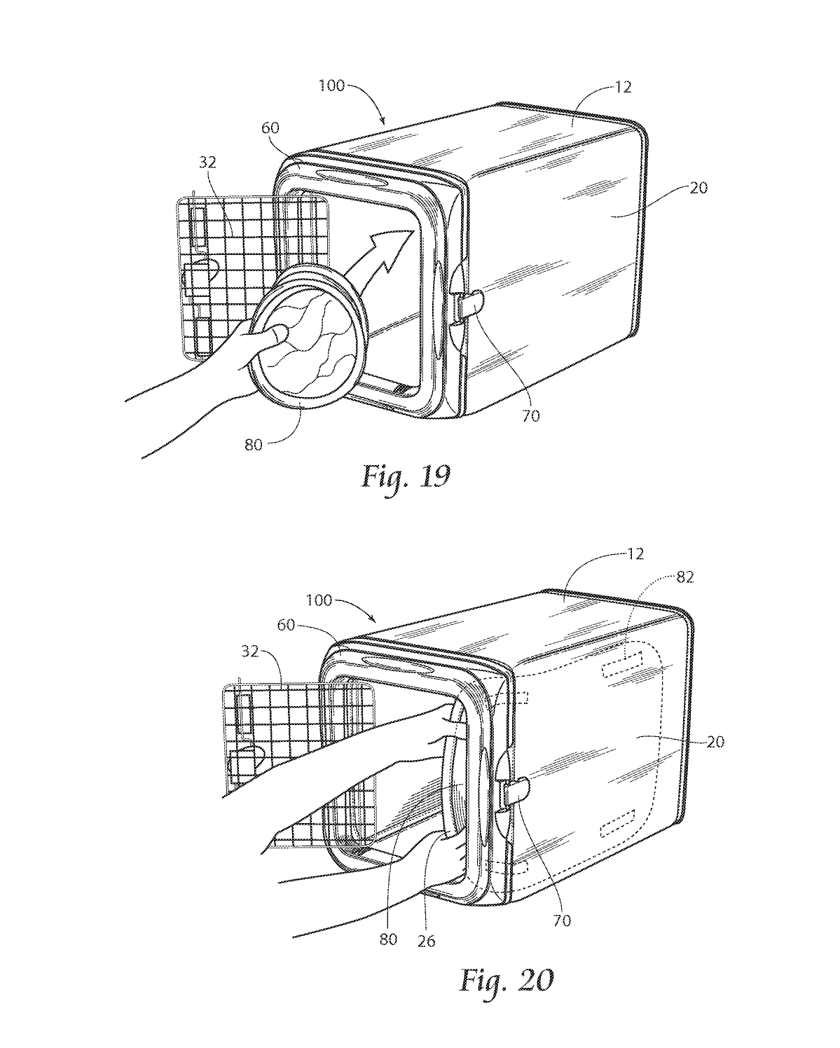

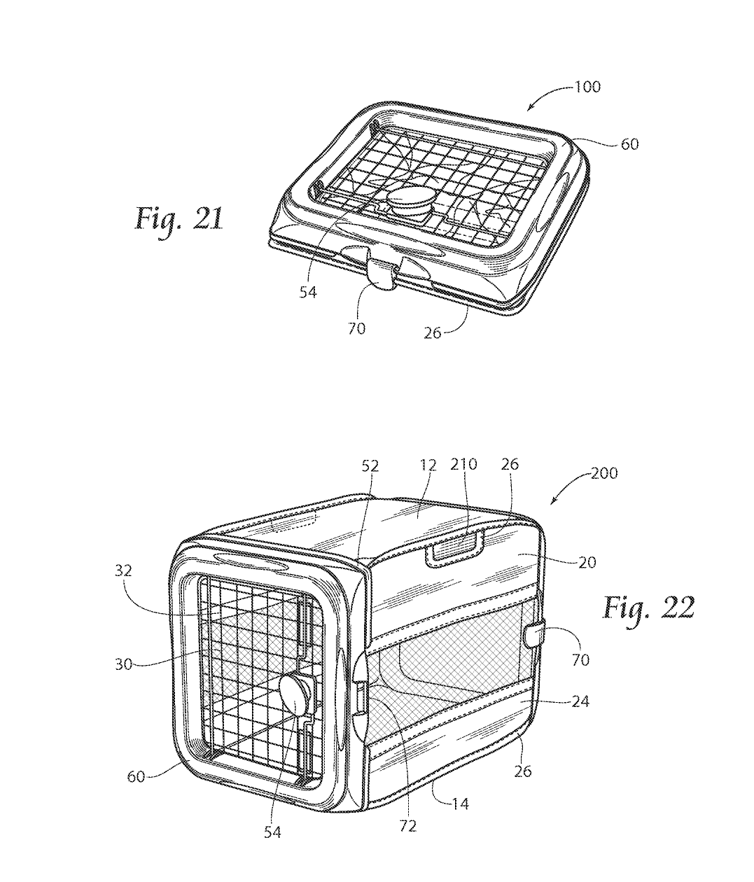

From the collapsed state, the kennel 100 may be opened into its expanded state for use. FIGS. 19 and 20 illustrate various steps for expanding the kennel 100 prior to use. Referring to FIG. 7, a first step includes placing a collapsed insert panel 80 into the kennel 100. As seen, the kennel 100 is in a generally expended condition, as the rigid border member 60 acts to hold the kennel opening 34 in an open position. When the collapsed insert panel 80 is released inside the kennel 100, the frame 22 biases the insert panel 80 into an expanded state. The insert panel 80 is then positioned adjacent a side panel 20, as is illustrated in FIG. 20. The insert panel 80 serves to provide added structure and rigidity to the side panel 20 and further aids in maintaining the kennel 100 in an expanded condition. As illustrated, multiple insert panels 80 may be contemplated in conjunction with the kennel 100, with a single insert panel 80 placed adjacent each respective side panel 20. Each insert panel 80 may be further provided with means for attachment to a respective side panel 20, such as the hook and loop fasteners 82 shown, although it is to be understood that other suitable attachment mechanisms may be considered such as tape, buttons or ties, by way of non-limiting examples. The kennel 100 may be collapsed in a manner similar to that described with reference to FIGS. 7-10, while leaving the insert panels 80 in place, if desired. FIG. 21 shows the final, collapsed condition of the kennel 100, with the latch members 70 on rigid border member 60 grasping the edging 26 of the rear panel 40 to thereby hold the kennel 100 in the collapsed state for storage and transportation.

The collapsed kennel 100 may be expanded when the latch members 70 are uncoupled from the edging 26. With the insert panels 80 in place within the collapsed kennel 100, the insert panel 80 frame members 22 will bias the kennel 100 into its fully expanded state shown in FIG. 16.

With attention now to FIG. 22, another embodiment of a collapsible kennel 200 may be seen. Similar to the previously described devices 10, 100, the collapsible kennel 200 in this view comprises a top panel 12, a bottom panel 14, two side panels 20, a front panel 30 having a door 32, and a rear panel 40 (not seen in this view). The top panel 12, bottom panel 14, and two side panels 20 are connected to one another to form a substantially rectangular enclosure 200 having the door 32 for ingress and egress.

As in the previous embodiments, each side panel 20 comprises a frame 22, a web 24, and an edging 26. The frame 22 is contained within the channel or pocket 25 formed by the edging 26 (best seen in FIG. 15). The webs 24 may be formed from a flexible foldable material, such as nylon cloth or nylon mesh, but can be any suitably flexible material. Further, the material may be solid or perforated. The perimeter of the web 24 is stitched to the edging 26 such that the edging 26 forms a pocket 25 about the periphery of the web 24. The edging 26 is a foldable, but stretch-resistant material capable of housing the frame 22 within its pocket 25. As may be further seen, at least one of the side panels 20 may further include a handhold opening 210. The handhold opening 210 may be used to transport, position, or otherwise move the structure 200 as may be required during use. As seen, the opening 210 is bounded by edging material 26 in a manner similar to that of the webs 24. As may be viewed, the perimeter of the opening 210 is stitched to the edging 26 for reinforcement and support. The edging 26 used in conjunction with the opening 210 is similar to the edging 26 used in other areas of the structure 10, 100, 200 and is a foldable but stretch-resistant material. The opening 210 may be located at any suitable position in a selected side panel 20, however the opening 210 is illustrated at a convenient, centered midpoint. Further, it is to be understood that, while not specifically shown, a handhold opening 210 may be used in conjunction with the collapsible kennel 100 illustrated in FIGS. 16-21.

As in previous embodiments, the top panel 12 and bottom panel 14 of kennel 200 preferably each comprise a continuous and non-interrupted foldable material. Each side panel web 24 preferably comprises a continuous and non-interrupted mesh material, or alternatively, may comprise a combination of mesh material and non-mesh foldable material.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. A collapsible pet kennel comprising:
a plurality of body panels, including opposed side panels, a top panel, and a floor panel;
a first end and a second end, said first end having an opening therein, said opening including a peripheral edging of stretch-resistant material;
each side panel including a web, looped frame, and a peripheral edging of stretch-resistant material, the frame being positioned in a pocket formed by the peripheral edging;
the top panel and the bottom panel being connected to the side panels; and
a rigid border member attached to said peripheral edging of said opening.

2. The collapsible pet kennel of claim 1 wherein at least one of said side panels includes a handhold opening therein.

3. The collapsible pet kennel of claim 1 wherein said looped frame of each said side panel forms a continuous loop.

4. The collapsible pet kennel of claim 3 wherein said opening includes a looped frame positioned in a pocket formed by the peripheral edging, said looped frame forming a continuous loop.

5. The collapsible pet kennel of claim 1 further including a door member positioned within the rigid border member.

6. The collapsible pet kennel of claim 1 wherein said second end includes a peripheral edging of stretch-resistant material.

7. The collapsible pet kennel of claim 6 wherein said second end includes a looped frame positioned in a pocket formed by the peripheral edging, and wherein said looped frame forms a continuous loop.

8. The collapsible pet kennel of claim 7 wherein said second end includes a rigid border member attached to said peripheral edging.

9. The collapsible pet kennel of claim 1 wherein said rigid border member includes a mounting element having an abutment to support said peripheral edging.

10. The collapsible pet kennel of claim 8 wherein said rigid border member on said second end includes a mounting element having an abutment to support said peripheral edging.

11. A method of collapsing a collapsible pet kennel comprising the steps of:
providing a collapsible pet kennel having a plurality of body panels, including opposed side panels, a top panel, and a floor panel, a first end and a second end, at least one end having an opening therein, each side panel including a web, looped frame, and a peripheral edging of stretch-resistant material, the frame being positioned in a pocket formed by the peripheral edging, and the top panel and the bottom panel being connected to the side panels, each end having a rigid frame member attached thereto; and
grasping a first rigid border member and rotating it 180° while compressing the side panels until the side panels are spiraled against each other and the first rigid border member is adjacent to and overlays a second rigid border member.

12. The method of claim 11 further including the steps of:
providing a first rigid frame member with fastener members and a second rigid frame member with corresponding latch members;
applying downward pressure on the collapsed kennel; and
pivoting said fastener members to catch said corresponding latch member.

13. A collapsible pet kennel comprising:
a plurality of body panels, including opposed side panels, a top panel, and a floor panel;
a first end and a second end, said first end having an opening therein, said opening including a peripheral edging of stretch-resistant material;
the top panel and the bottom panel being connected to the side panels; and
a rigid border member attached to said peripheral edging of said opening.

14. The collapsible pet kennel of claim 13 further including at least one insert panel positioned inside the kennel and adjacent a selected side panel, said at least one insert panel including a web, looped frame, and a peripheral edging of stretch-resistant material, the frame being positioned in a pocket formed by the peripheral edging.

15. The collapsible pet kennel of claim 14 wherein at least one of said side panels includes a handhold opening therein.

16. The collapsible pet kennel of claim 14 wherein said looped frame of said at least one insert panel forms a continuous loop.

17. The collapsible pet kennel of claim 16 wherein said opening includes a looped frame positioned in a pocket formed by the peripheral edging, said looped frame forming a continuous loop.

18. The collapsible pet kennel of claim 13 further including a door member positioned within the rigid border member.

19. The collapsible pet kennel of claim 13 wherein said second end includes a peripheral edging of stretch-resistant material.

20. The collapsible pet kennel of claim 13 wherein said rigid border member includes a mounting element having an abutment to support said peripheral edging.

21. The collapsible pet kennel of claim 13 wherein each side panel includes a web, looped frame, and a peripheral edging of stretch-resistant material, the frame being positioned in a pocket formed by the peripheral edging.
